(19) United States
(12) Patent Application Publication
(10) Pub. No.: US 2014/0372212 A1
(43) Pub. Date: Dec. 18, 2014

(54) RELEVANCE INDEX CORRECTION APPARATUS AND RELEVANCE INDEX CORRECTION METHOD

(71) Applicant: YAHOO JAPAN CORPORATION, Tokyo (JP)

(72) Inventors: Toru HOTTA, Tokyo (JP); Yusuke TANAKA, Tokyo (JP); Yukihiro TAGAMI, Tokyo (JP)

(21) Appl. No.: 14/306,543

(22) Filed: Jun. 17, 2014

(30) Foreign Application Priority Data
Jun. 18, 2013 (JP) 2013-127725

(51) Int. Cl. G06Q 30/02

(52) U.S. Cl. CPC G06Q 30/0251
USPC 705/14.49

(57) ABSTRACT

A relevance index correction apparatus includes an attribute information obtainer, a relevance index generator, and a specific relevance index calculator. The attribute information obtainer obtains, in response to selection of a specific piece of advertisement information that is to be posted on a web page, attribute information related to the specific piece of advertisement information. The relevance index generator generates an apparent relevance index and a mean relevance index. The apparent relevance index indicates an apparent degree of relevance of the attribute information with respect to the specific piece of advertisement information. The mean relevance index indicates a mean degree of relevance of the attribute information with respect to all of a plurality of pieces of advertisement information. The specific relevance index calculator calculates a specific relevance index that indicates a true degree of relevance of the attribute information with respect to the specific piece of advertisement information.

### CROSS-REFERENCE TO RELATED APPLICATIONS

The present invention contains subject matter related to Japanese Patent Application No. 2013-127725 filed in the Japan Patent Office on Jun. 18, 2013, the entire contents of which are incorporated herein by reference.

### BACKGROUND OF THE INVENTION

1. Field of the Invention

The present invention relates to a relevance index correction apparatus and a relevance index correction method.

2. Description of the Related Art

A web page displayed on a display screen of a terminal is provided with an advertisement frame. Within the advertisement frame, advertisement information is posted. When the advertisement information is selected by a user (reader), a web page of the advertiser is displayed. To efficiently lead a user to a web page of an advertiser via advertisement information, attribute information about a web page or attribute information about a user that have previously been selected with high frequency for specific advertisement information are extracted. The attribute information extracted in this manner is recognized in advance as being highly relevant to the specific advertisement information (see, for example, Japanese Unexamined Patent Application Publication No. 2011-238020).

Even if a history is recognized in which specific advertisement information has been selected by users of a specific age group (for example, users in their twenties) with high frequency, the users of the specific age group may tend to uniformly select other advertisement information with high frequency. In this case, the specific advertisement information is actually not particularly interesting to the users of the specific age group.

### SUMMARY OF THE INVENTION

According to an embodiment of the present invention, there is provided a relevance index correction apparatus including an attribute information obtainer, a relevance index generator, and a specific relevance index calculator. The attribute information obtainer obtains, in response to selection of a specific piece of advertisement information that is to be posted on a web page, attribute information related to the specific piece of advertisement information. The relevance index generator generates an apparent relevance index and a mean relevance index. The apparent relevance index indicates an apparent degree of relevance of the attribute information with respect to the specific piece of advertisement information. The mean relevance index indicates a mean degree of relevance of the attribute information with respect to all of a plurality of pieces of advertisement information. The specific relevance index calculator calculates, in accordance with the apparent relevance index and the mean relevance index, a specific relevance index that indicates a true degree of relevance of the attribute information with respect to the specific piece of advertisement information.

Further features of the embodiments of the present invention will become apparent from the following description of the embodiments given below with reference to the attached drawings.

### BRIEF DESCRIPTION OF THE DRAWINGS

FIG. 1 is a diagram illustrating an overall configuration of a relevance research system according to a first embodiment;

FIG. 2 is a block diagram illustrating a schematic inner configuration of a relevance index correction apparatus according to the first embodiment;

FIG. 3 illustrates an example of a web page displayed on a display screen of a terminal;

FIG. 4 is a schematic explanatory diagram illustrating acquisition of attribute information and generation of an apparent relevance index and a mean relevance index;

FIG. 5 is a diagram illustrating a schematic data structure of a first database;

FIG. 6 is a diagram illustrating a schematic data structure of a second database;

FIG. 7 is a diagram illustrating a schematic data structure of a third database;

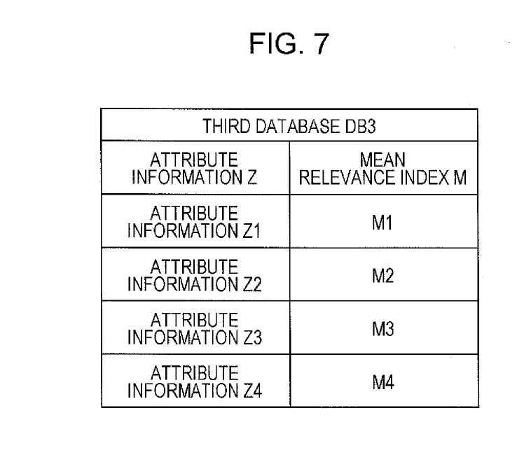

FIG. 8 is a diagram illustrating an overall configuration of a relevance research system according to a second embodiment;

FIG. 9 is a block diagram illustrating a schematic inner configuration of a relevance index correction apparatus according to the second embodiment;

FIG. 10 is a diagram illustrating a schematic data structure of a fourth database; and

FIG. 11 is a diagram illustrating a schematic data structure of a fifth database.

### DETAILED DESCRIPTION OF THE EMBODIMENTS

The applicant has developed a new method for grasping the relevance between attribute information about a user or a web page and specific advertisement information by taking into consideration the trend of mean selection frequency of all pieces of advertisement information, in view of a possibility that, if attribute information related to high selection frequency of specific advertisement information is determined to be highly relevant to the specific advertisement information, the attribute information is not actually highly relevant to the specific advertisement information.

Embodiments of the present invention have been made in view of the above-described circumstances, and provide a relevance index correction apparatus and a relevance index correction method that are configured to grasp the relevance between specific advertisement information and attribute information about a user or a web page more appropriately than in a case where the relevance is grasped from a history about selection of only target specific advertisement information.

### First Embodiment

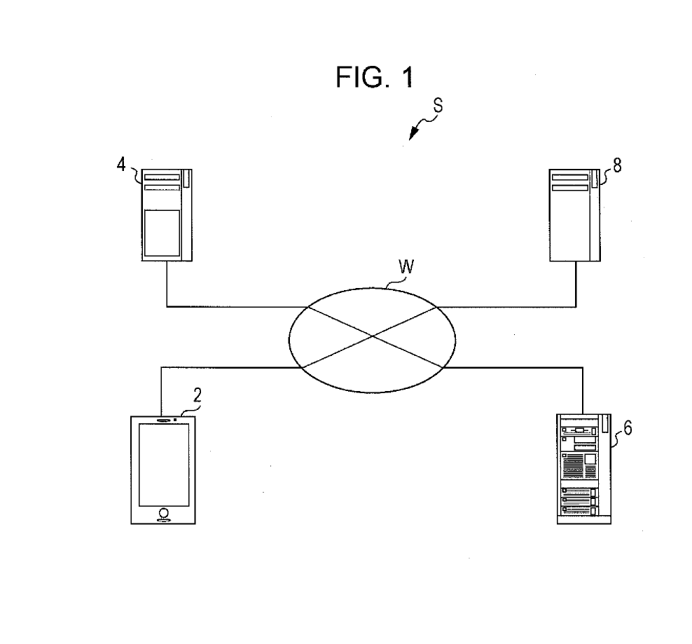

Hereinafter, a first embodiment will be described with reference to the attached drawings. FIG. 1 is a diagram illustrating an overall configuration of a relevance research system S according to the first embodiment of the present invention. The relevance research system S includes a terminal 2, a content server 4, a relevance index correction apparatus 6, and an advertiser server 8, which are connected to one another via the Internet W.

Terminal 2

The terminal 2 is owned, used, or managed by a user, and may be, for example, a mobile phone, a personal computer, a smart phone, a tablet terminal, or the like. The terminal 2 includes an arithmetic processor and a memory therein, and is provided with a display screen. The terminal 2 may include an input device, such as a keyboard. The keyboard may be a software keyboard. The terminal 2 is connected to the Internet W directly or indirectly, and is capable of communicating with the content server 4 via the Internet W.

With the use of, for example, an application program such as an Internet browser, the terminal 2 receives web content information from the content server 4 via the Internet W.

Content Server 4

The content server 4 provides web content information (hereinafter simply referred to as content information) to a user. Examples of the content information include news information, blog information, and Internet shop information. The content server 4 is capable of transmitting information to and receiving information from the terminal 2 in a wired or wireless manner, and is capable of transmitting content information to the terminal 2.

When content information is displayed on the display screen of the terminal 2, an advertisement frame H is placed at a portion of the page layout of the content information. Advertisement information AD (distributed information) to be posted in the advertisement frame H is distributed from an advertisement information distribution apparatus (not illustrated).

Advertiser Server 8

The advertiser server 8 has a function of providing detailed information about an item or the like to the terminal 2 in response to a request from the terminal 2. The advertiser server 8 has a site page in which an advertiser site is constructed. Detailed information about an item or the like is displayed on the site page.

If advertisement information AD displayed on the terminal 2 is an advertisement such as a banner advertisement, and if the advertisement is embedded with link information linking to the advertiser server 8, a request signal is transmitted from the terminal 2 to the advertiser server 8 upon click (selection) of the advertisement on the terminal 2. In response to the request signal, the advertiser server 8 transmits information about a site page containing detailed information abut an item or the like to the terminal 2. Accordingly, the site page of the advertiser server 8 is displayed on the display screen of the terminal 2, and the detailed information about an item or the like is provided to the user of the terminal 2.

Relevance Index Correction Apparatus 6

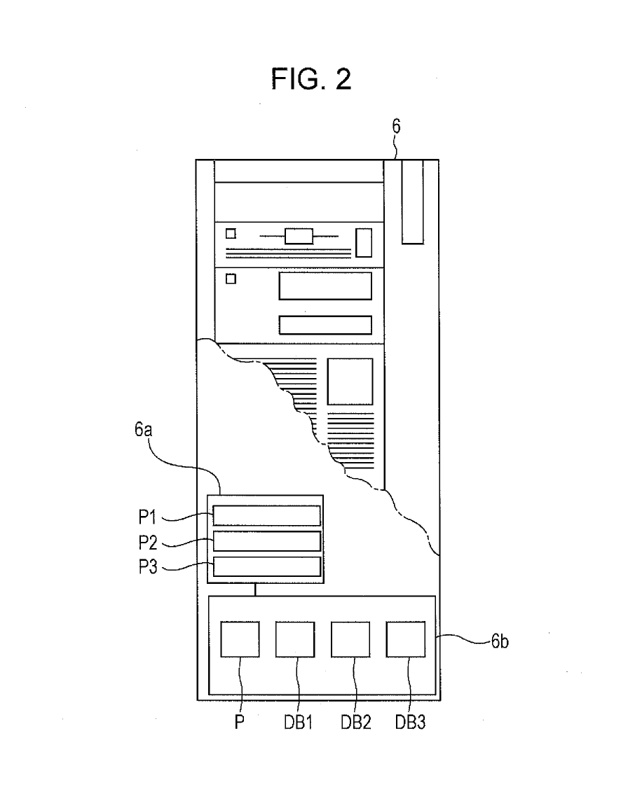

FIG. 2 is a block diagram illustrating a schematic inner configuration of the relevance index correction apparatus 6. The relevance index correction apparatus 6 includes a central processing unit (CPU, an arithmetic processor) 6a and a memory 6b therein, which serve as a main part of a computer. The memory 6b stores a relevance index correction program P, a first database DB1, a second database DB2, and a third database DB3.

In accordance with the relevance index correction program P, the CPU 6a functions as an attribute information obtainer P1, a relevance index generator P2, and a specific relevance index calculator P3. Hereinafter, a description will be given of the individual functions that are implemented by the CPU 6a in accordance with the relevance index correction program P.

Attribute Information Obtainer P1

The attribute information obtainer P1 has a function of obtaining, in response to selection of specific advertisement information AD posted on a web page 5, attribute information Z related to the specific advertisement information AD.

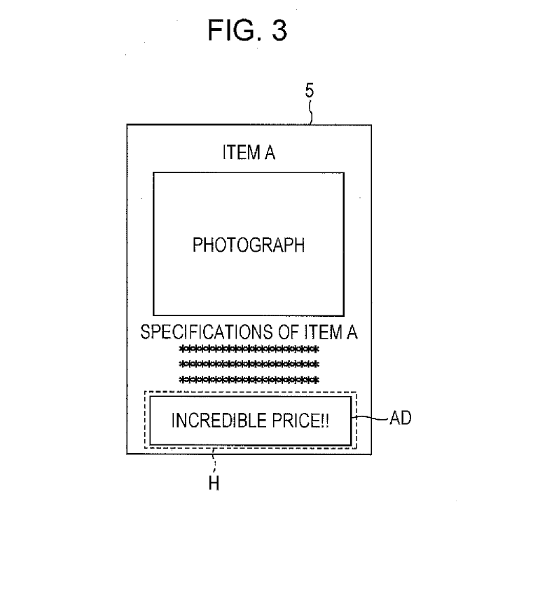

FIG. 3 illustrates an example of the web page 5 displayed on the display screen of the terminal 2. The web page 5 contains advertisement information AD posted in the advertisement frame H, in addition to information about an item, news information, blog information, or the like. When a user (reader) selects the advertisement information AD, a web page 5 which contains detailed information about an item or the like is displayed.

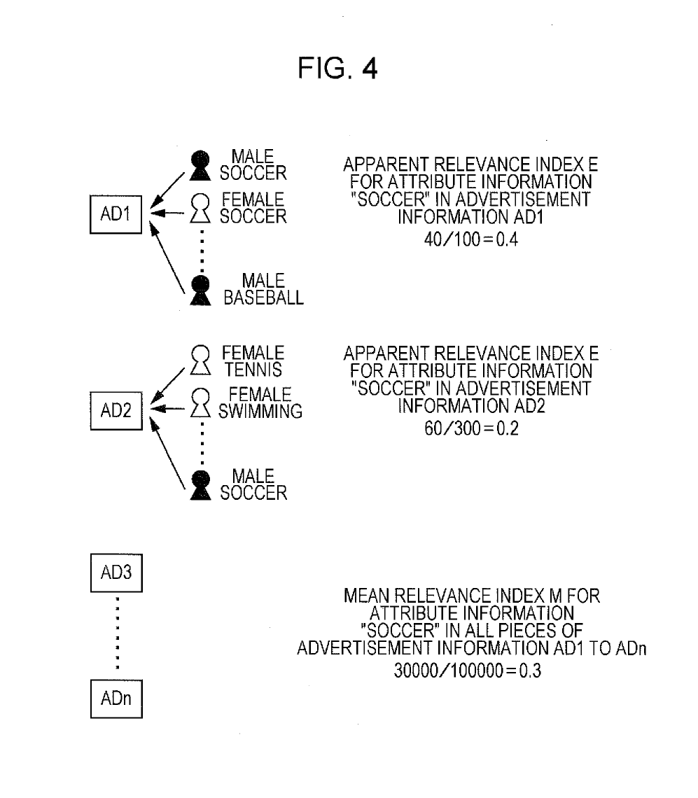

FIG. 4 is a schematic explanatory diagram illustrating acquisition of the attribute information Z and generation of an apparent relevance index E and a mean relevance index M. In response to user's selection of the advertisement information AD posted on the web page 5, various types of attribute information Z is obtained. The attribute information Z is obtained in association with, for example, information about sex or hobby of a user who has selected specific advertisement information AD1, information about the details of an article contained in a web page on which the advertisement information AD1 is posted when the advertisement information AD1 is selected, information about the time, day, or season when the advertisement information AD1 is selected, information about the place where the terminal 2 is located when the advertisement information AD1 is selected.

For example, a category “user's hobby” of the attribute information Z may have sub-categories, such as “sport”, “movie”, and “reading books”. In the sub-category “sport”, individual kinds of sport, such as soccer, baseball, tennis, and swimming may be determined as the attribute information Z.

For example, a rule may be established so that, in a case where a user who selects the advertisement information AD1 is male, and is a soccer fan and a baseball fan, “male”, “soccer”, and “baseball” are obtained as attribute information Z related to the advertisement information AD1. In addition to the foregoing rule, a rule may be established so that, in case where a female user selects the advertisement information AD1 while the advertisement information AD1 appears on the web page 5 related to soccer, “female” and “soccer” are obtained as attribute information Z related to the advertisement information AD1.

Attribute information Z related to specific advertisement information AD is stored in the first database DB1 upon being obtained by the attribute information obtainer P1.

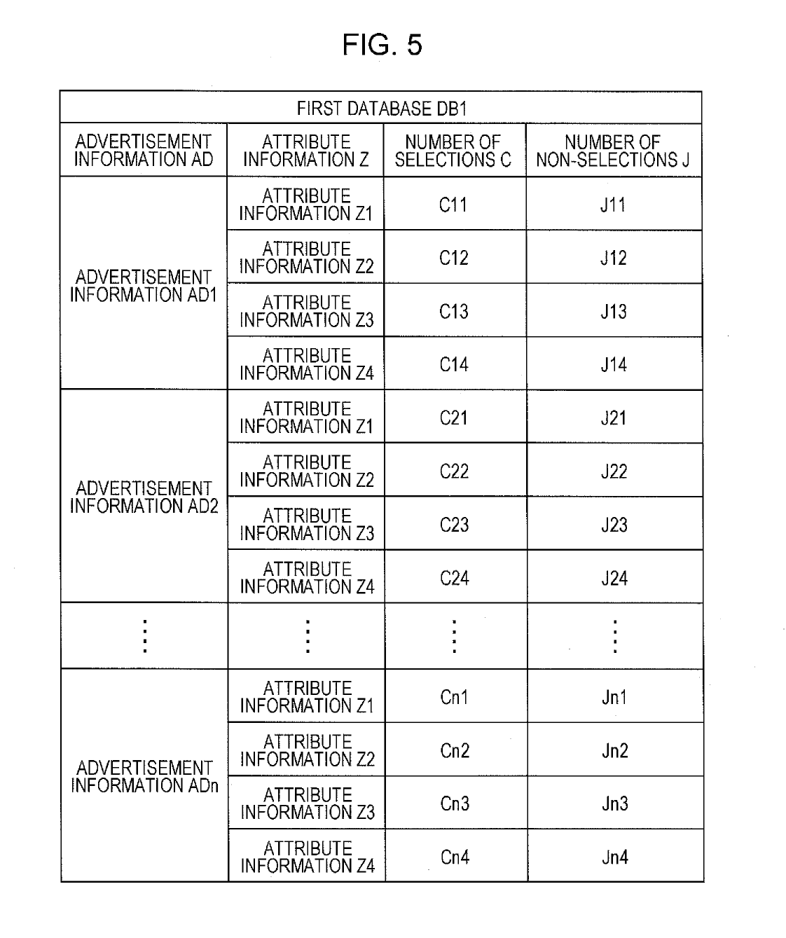

FIG. 5 is a diagram illustrating a schematic data structure of the first database DB1. The first database DB1 is constructed such that attribute information Z, the number of selections C, and the number of non-selections J are associated with one another for each piece of advertisement information AD. For example, it is assumed that attribute information Z1 represents “male”, attribute information Z2 represents “female”, attribute information Z3 represents “soccer”, and attribute information Z4 represents “baseball”. Under the above-described rules about acquisition of attribute information, it is assumed that one event occurs in which a male user who is a soccer fan and a baseball fan selects the advertisement information AD1. In this case, regarding the advertisement information AD1, “1” is added to each of the number of selections C11 for the attribute information Z1 “male”, the number of selections C13 for the attribute information Z3 “soccer”, and the number of selections C14 for the attribute information Z4 “baseball”. Furthermore, in this case, regarding the attribute information Z2 for which “1” is not added to the number of selections C, that is, attribute information “female”, “1” is added to the number of non-selections J12. The sum of the number of selections C and the number of non-selections J for specific attribute information Z of specific advertisement information AD corresponds to the total number of selections that have occurred for the specific advertisement information AD.

Relevance Index Generator P2

The relevance index generator P2 has a function of generating an apparent relevance index E that indicates an apparent degree of relevance of attribute information Z with respect to a specific piece of advertisement information AD, and a mean relevance index M that indicates a mean degree of relevance of attribute information Z with respect to all of a plurality of pieces of advertisement information AD.

The apparent relevance index E indicates a percentage at which selection related to specific attribute information Z has occurred in specific advertisement information AD. For example, the apparent relevance index E for the attribute information Z1 in the advertisement information AD1 may be generated as a ratio of the number of selections C11 to the sum of the number of selections C11 and the number of non-selections J11 for the attribute information Z1 in the advertisement information AD1 (=C11/(C11+J11)).

As illustrated in FIG. 4, it is assumed that selection related to the attribute information “soccer” has occurred 40 times in a case where selection of the advertisement information AD1 has occurred 100 times. In this case, the number of selections C is “40” and the number of non-selections J is “60” for the attribute information “soccer” in the advertisement information AD1. The apparent relevance index E for the attribute information “soccer” in the advertisement information AD1 is 0.4 (=40/100).

The apparent relevance index E for specific attribute information Z in specific advertisement information AD is stored in the second database DB2 after being generated by the relevance index generator P2.

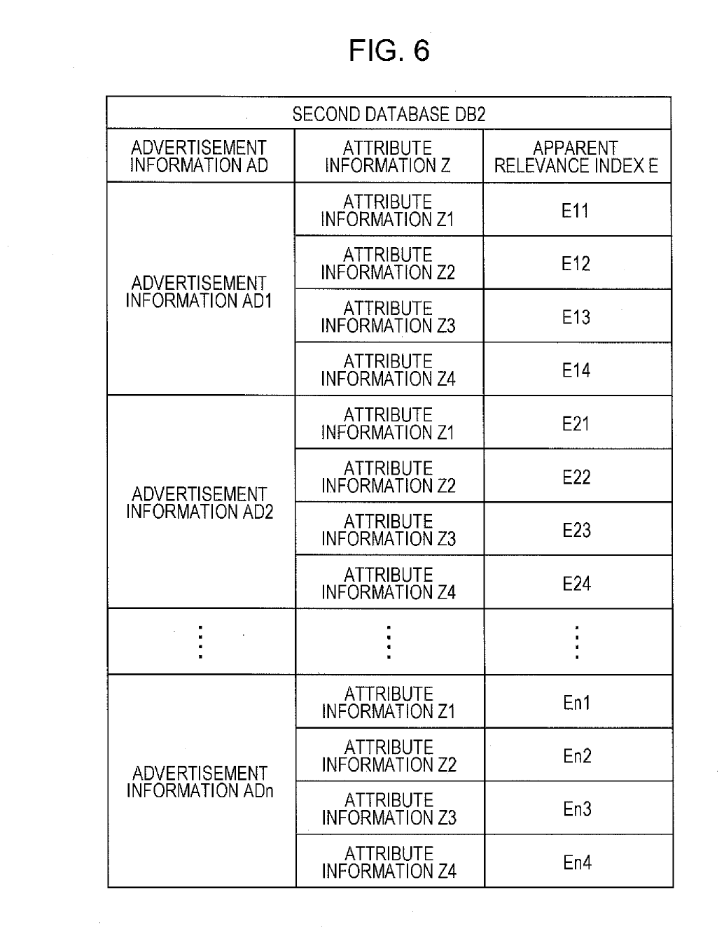

FIG. 6 is a diagram illustrating a schematic data structure of the second database DB2. The second database DB2 is constructed such that attribute information Z and an apparent relevance index E are associated with each other for each piece of advertisement information AD. For example, the apparent relevance index E for the attribute information Z1 in the advertisement information AD1 is E11. The apparent relevance index E for the attribute information Z2 in the advertisement information AD1 is E12.

The mean relevance index M indicates a percentage at which selection related to specific attribute information Z has occurred in all of a plurality of pieces of advertisement information AD.

In a case where a mean relevance index M is generated, a plurality of pieces of advertisement information AD may include or not include a specific piece of advertisement information AD for which a specific relevance index F is to be obtained. For example, it is assumed that a specific piece of advertisement information AD for which a specific relevance index F is to be obtained is the advertisement information AD1. In this case, a plurality of pieces of advertisement information AD for which a mean relevance index M is to be generated may include or not include the advertisement information AD1. In a case where the advertisement information AD1 is included, a mean relevance index M is generated from all the pieces of advertisement information AD1 to ADn. In a case where the advertisement information AD1 is not included, a mean relevance index M is generated from all the pieces of advertisement information AD2 to ADn.

Hereinafter, a description will be given of a case where a plurality of pieces of advertisement information AD for which a mean relevance index M is to be generated include a specific piece of advertisement information AD for which a specific relevance index F is to be obtained.

As illustrated in FIG. 4, it is assumed that, in a case where selection occurs one hundred thousand times in all the pieces of advertisement information AD1 to ADn, selection related to the attribute information “soccer” occurs thirty thousand times among the one hundred thousand times. In this case, the mean relevance index for the attribute information “soccer” is 0.3 (=30000/100000).

The mean relevance index M is a mean value of apparent relevance indices E for the pieces of advertisement information AD1 to ADn about specific attribute information Z, which is obtained by adding the apparent relevance indices E and dividing the resulting sum by the total number n of the pieces of advertisement information AD. For example, a mean relevance index M1 for the attribute information Z1 can be obtained by adding the apparent relevance index E11 for the attribute information Z1 in the advertisement information AD1 through an apparent relevance index En1 for the attribute information Z1 in the advertisement information ADn, and by dividing the resulting sum by the total number n of the pieces of advertisement information.

The mean relevance index M for the specific attribute information Z is stored in the third database DB3 after being generated by the relevance index generator P2.

The third database DB3 is constructed such that attribute information Z and a mean relevance index M are associated with each other. For example, the mean relevance index for the attribute information Z1 is M1. The mean relevance index for the attribute information Z2 is M2.

Specific Relevance Index Calculator P3

The specific relevance index calculator P3 has a function of calculating a specific relevance index F that indicates a true degree of relevance of attribute information Z with respect to specific advertisement information AD on the basis of an apparent relevance index E and a mean relevance index M.

A specific relevance index F may be calculated by subtracting a mean relevance index M from an apparent relevance index E.

Here, a description will be given of a case where a specific relevance index F is calculated by subtracting a mean relevance index M from an apparent relevance index E. For example, the specific relevance index F for the attribute information “soccer” in the advertisement information AD1 illustrated in FIG. 4 is “0.1”, which is calculated by subtracting “0.3”, which is a mean relevance index, from “0.4”, which is the apparent relevance index E for the attribute information “soccer”. The fact that the specific relevance index F is “0.1”, that is, a positive value, means that the degree of relevance between the advertisement information AD1 and the attribute information “soccer” is higher than the mean relevance between the attribute information “soccer” and all the pieces of advertisement information AD. In the relationship between the advertisement information AD1 and the attribute information “soccer” illustrated in FIG. 4, the advertisement information AD1 has a strong appeal to users who are soccer fans.

The specific relevance index F for the attribute information “soccer” in the advertisement information AD2 illustrated in FIG. 4 is “−0.1”, which is calculated by subtracting “0.3”, which is a mean relevance index, from “0.2”, which is the apparent relevance index E for the attribute information “soccer”. The fact that the specific relevance index F is “−0.1”, that is, a negative value, means that the degree of relevance between the advertisement information AD2 and the attribute information “soccer” is lower than the mean relevance between the attribute information “soccer” and all the pieces of advertisement information AD. In the relationship between the advertisement information AD2 and the attribute information “soccer” illustrated in FIG. 4, the advertisement information AD2 has a weak appeal to users who are soccer fans, that is, does not attract users who are soccer fans.

Alternatively, a specific relevance index F may be calculated by using the following equation (I) in accordance with an apparent relevance index E and a mean relevance index M.

F=log(E/M) Equation (I)

Alternatively, a specific relevance index F may be calculated by using an equation for calculating a probability that a specific piece of advertisement information AD will be selected compared to all of a plurality of pieces of advertisement information AD, on the basis of a mutual amount of information about user attributes and clicking of an advertisement.

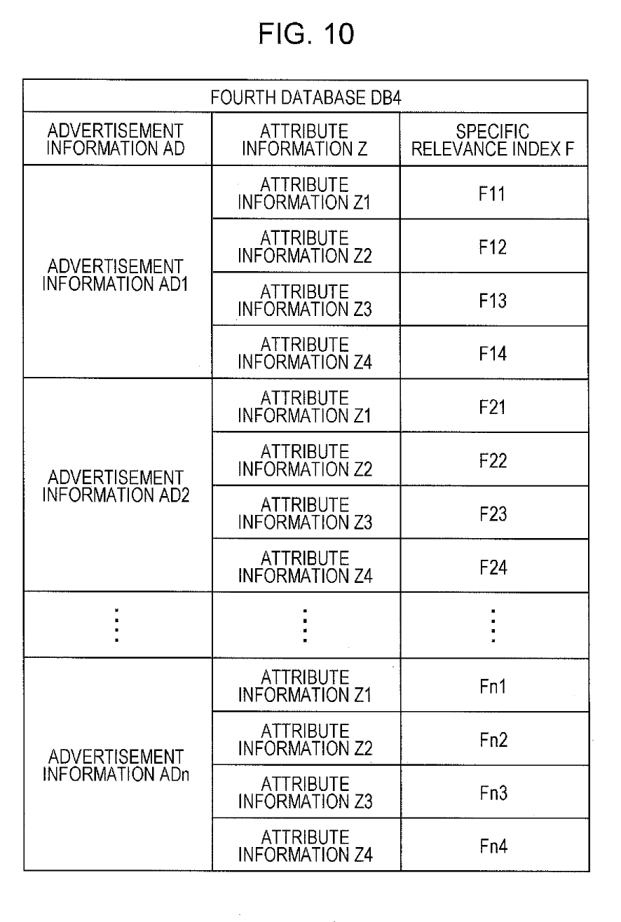

Although not illustrated, a specific relevance index F may be stored in a database inside the memory 6b of the relevance index correction apparatus 6 (see FIG. 10, which will be described below).

### Second Embodiment

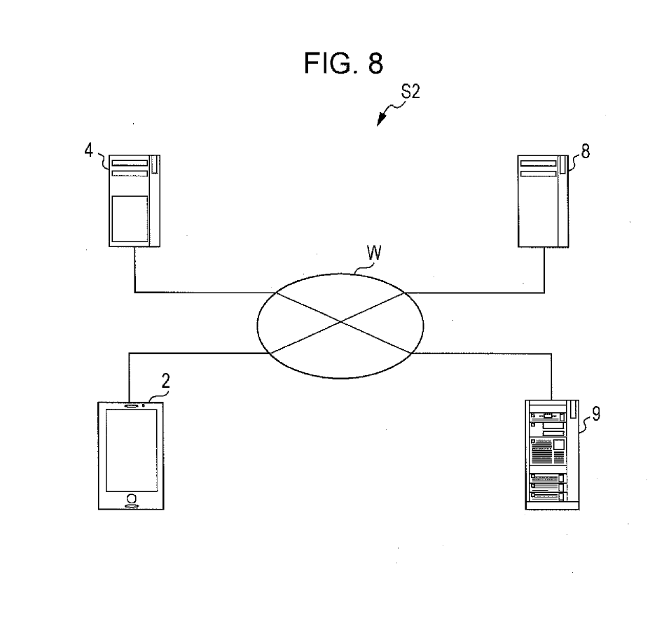

Hereinafter, a second embodiment will be described with reference to the attached drawings. In the second embodiment, the same parts as those in the first embodiment are denoted by the same reference numerals, and the description thereof is omitted. FIG. 8 is a diagram illustrating an overall configuration of a relevance research system S2 according to the second embodiment. The relevance research system S2 includes the terminal 2, the content server 4, a relevance index correction apparatus 9, and the advertiser server 8, which are connected to one another so as to be capable of transmitting and receiving information via the Internet W.

In the second embodiment, the configurations and functions of the terminal 2, the content server 4, and the advertiser server 8 are almost the same as those described above in the first embodiment, and thus the detailed description thereof is omitted here.

Relevance Index Correction Apparatus 9

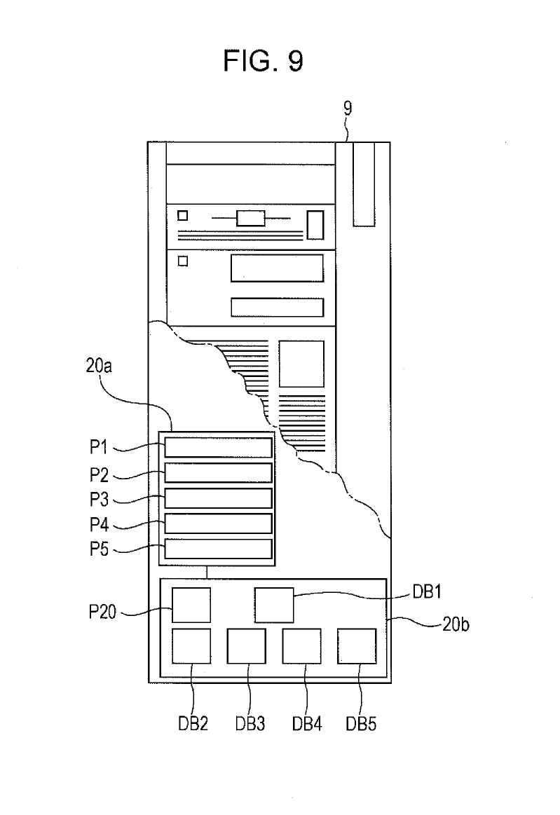

FIG. 9 is a block diagram illustrating a schematic inner configuration of the relevance index correction apparatus 9. The relevance index correction apparatus 9 includes a CPU (an arithmetic processor) 20a and a memory 20b therein, which serve as a main part of a computer. The memory 20b stores a relevance index correction program P20, the first database DB1, the second database DB2, the third database DB3, a fourth database DB4, and a fifth database DB5.

In accordance with the relevance index correction program P20, the CPU 20a functions as the attribute information obtainer P1, the relevance index generator P2, the specific relevance index calculator 93, a characteristic attribute generator P4, and a selector P5.

Hereinafter, a description will be given of the individual functions that are implemented by the CPU 20a in accordance with the relevance index correction program P20. In the second embodiment, the configurations and functions of the attribute information obtainer P1, the relevance index generator P2, and the specific relevance index calculator P3 are almost the same as those described above in the first embodiment, and thus the detailed description thereof is omitted here.

Characteristic Attribute Generator P4

The characteristic attribute generator P4 has a function of generating a characteristic attribute G of one piece of advertisement information AD by extracting attribute information Z for which a specific relevance index F has a positive value for the one piece of advertisement information AD.

FIG. 10 is a diagram illustrating a schematic data structure of the fourth database DB4. The fourth database DB4 is constructed such that attribute information Z and a specific relevance index F are associated with each other for each piece of advertisement information AD. For example, the specific relevance index for attribute information Z1 in advertisement information AD1 is F11. The specific relevance index for attribute information Z2 in the advertisement information AD1 is F12.

The characteristic attribute generator P4 retrieves data from the fourth database D24, and extracts, for each piece of advertisement information AD, attribute information Z for which the specific relevance index F has a positive value. The extracted attribute information Z for which the specific relevance index F has a positive value is generated as a characteristic attribute G of the corresponding piece of advertisement information AD.

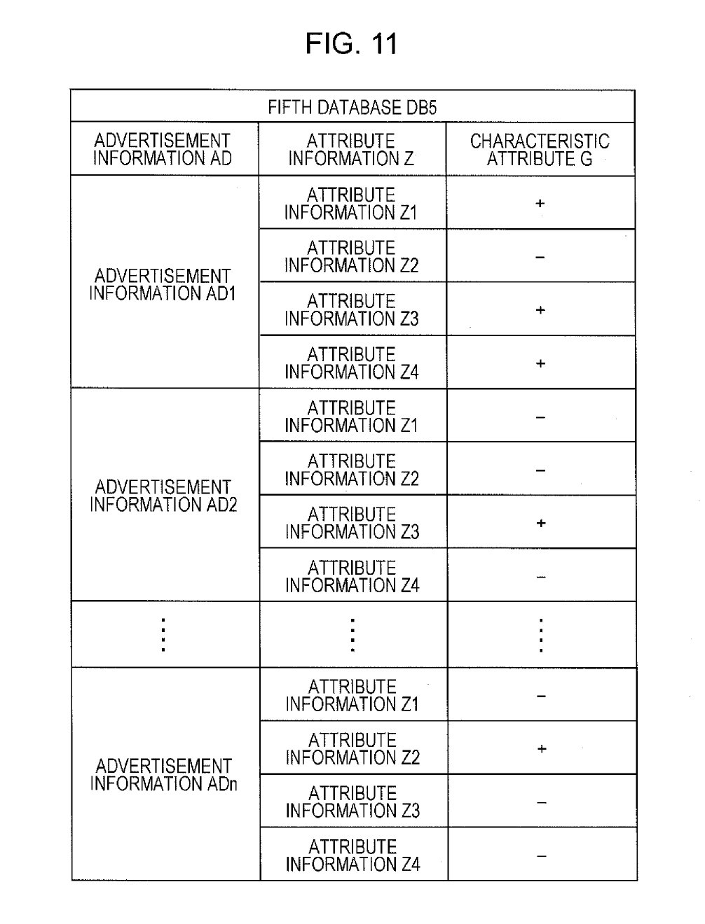

FIG. 11 is a diagram illustrating a schematic data structure of the fifth database DB5. The fifth database DB5 is constructed such that attribute information Z and a characteristic attribute G are associated with each other for each piece of advertisement information AD. For example, it is assumed that, in the advertisement information AD1, the specific relevance index F11 for the attribute information Z1 is a positive value. In this case, the attribute information Z1 is generated as a characteristic attribute G of the advertisement information AD1 (the characteristic attribute G is stored as “+” in the fifth database DB5). It is assumed that, in the advertisement information AD1, the specific relevance index F12 for the attribute information Z2 is a negative value. In this case, the attribute information Z2 is not generated as a characteristic attribute G of the advertisement information AD1 (the characteristic attribute G is stored as “-” in the fifth database DB5).

In the advertisement information AD1 illustrated in FIG. 11, attribute information Z1, attribute information Z3, and attribute information Z4 are generated as a characteristic attribute G. For example, in a case where the attribute information Z1 represents “male”, the attribute information Z2 represents “female”, the attribute information Z3 represents “soccer”, and the attribute information Z4 represents “baseball”, the characteristic attribute G of the advertisement information AD1 is generated so as to include “male”, “soccer”, and “baseball”, and not to include “female”. In the advertisement information AD2 illustrated in FIG. 11, only the attribute information Z3 among the pieces of attribute information Z1 to Z4 is generated as a characteristic attribute G. For example, in a case where the attribute information Z1 represents “male”, the attribute information Z2 represents “female”, the attribute information Z3 represents “soccer”, and the attribute information Z4 represents “baseball”, the characteristic attribute G of the advertisement information AD2 is generated so as to include “soccer”, and not to include “male”, “female”, and “baseball”.

Selector P5

The selector P5 has a function of selecting a web page 5 to which one piece of advertisement information AD is to be distributed on the basis of a characteristic attribute G.

Selection of the web page 5 by the selector P5 may be performed, on the basis of the identity, similarity, or relevance between the characteristic attribute G of specific advertisement information AD and the attribute information Z about the specific web page 5, so that the specific web page 5 becomes a destination to which the specific advertisement information AD is to be distributed.

Selection of the web page 5 by the selector P5 may be performed, on the basis of the identity, similarity, or relevance between the characteristic attribute G of specific advertisement information AD and the attribute information Z about the user of the terminal 2 on which the web page 5 is displayed, so that the specific web page 5 becomes a destination to which the specific advertisement information AD is to be distributed.

For example, the attribute information Z “car” (characteristic attribute G) has a high degree of similarity with “bicycle”, which is transportation like a car, and has a high degree of relevance with “tire”, which is a component of a car. The attribute information Z “car” (characteristic attribute G) has a low degree of similarity and relevance with “telephone” and “high heels”, which are not transportation and are not normally categorized as components of a car. For example, in a case where the characteristic attribute G of certain advertisement information AD is “car” and where the attribute information Z about a web page 5 represents “bicycle” or “tire”, the selector P5 may function to select the web page 5 as a distribution destination. At this time, in a case where the attribute information about the web page 5 represents “telephone” or “high heels” and does not include attribute information having a high degree of similarity or relevance, such as “car” or “tire”, the selector P5 may function to eliminate the web page 5 from candidate distribution destinations.

The attribute information obtainer P1 may have a function of obtaining attribute information Z about a user as attribute information related to specific advertisement information AD.

The attribute information Z about a user is obtained on the basis of, for example, information about sex or hobby of the user, information about an article displayed on a web page that is read by the user with high frequency or for a long time, information about the residence of the user, or the like.

The attribute information obtainer P1 may have a function of obtaining attribute information Z about the web page 5 as attribute information Z related to specific advertisement information AD.

The attribute information Z about the web page 5 is obtained on the basis of, for example, information about an article contained in the web page, information about a manager of the web page, information about a user (reader) who reads the web page with high frequency or for a long time, or the like.

The attribute information obtainer P1 may have a function of obtaining attribute information Z that is based on information input to the web page 5 by the user as attribute information Z related to specific advertisement information AD.

The attribute information that is based on information input by the user is obtained on the basis of, for example, information about a keyword input to a search engine by the user.

Embodiments of the present invention include the following configuration.

According to an embodiment of the present invention, there is provided a relevance index correction apparatus including an attribute information obtainer, a relevance index generator, and a specific relevance index calculator. The attribute information obtainer obtains, in response to selection of a specific piece of advertisement information that is to be posted on a web page, attribute information related to the specific piece of advertisement information. The relevance index generator generates an apparent relevance index and a mean relevance index. The apparent relevance index indicates an apparent degree of relevance of the attribute information with respect to the specific piece of advertisement information. The mean relevance index indicates a mean degree of relevance of the attribute information with respect to all of a plurality of pieces of advertisement information. The specific relevance index calculator calculates, in accordance with the apparent relevance index and the mean relevance index, a specific relevance index that indicates a true degree of relevance of the attribute information with respect to the specific piece of advertisement information.

According to another embodiment of the present invention, there is provided a relevance index correction method. The method includes obtaining, in response to selection of a specific piece of advertisement information that is to be posted on a web page, attribute information related to the specific piece of advertisement information; generating an apparent relevance index that indicates an apparent degree of relevance of the attribute information with respect to the specific piece of advertisement information; generating a mean relevance index that indicates a mean degree of relevance of the attribute information with respect to all of a plurality of pieces of advertisement information; and calculating, in accordance with the apparent relevance index and the mean relevance index, a specific relevance index that indicates a true degree of relevance of the attribute information with respect to the specific piece of advertisement information.

According to the embodiments of the present invention, the relevance between specific advertisement information and attribute information about a user or a web page may be grasped more appropriately than in a case where the relevance is grasped from a history about selection of only target specific advertisement information.

The specific relevance index calculator may calculate the specific relevance index by subtracting the mean relevance index from the apparent relevance index.

The specific relevance index calculator may calculate the specific relevance index, which is represented by F, in accordance with the apparent relevance index, which is represented by E, and the mean relevance index, which is represented by M, by using an equation F=log (E/M).

The relevance index correction apparatus may further include a characteristic attribute generator configured to generate a characteristic attribute of one of the plurality of pieces of advertisement information by extracting the attribute information for which the specific relevance index has a positive value for the one piece of advertisement information, and a selector configured to select, in accordance with the characteristic attribute, the web page to which the one piece of advertisement information is to be distributed.

The attribute information obtainer may obtain attribute information about a user as the attribute information related to the specific piece of advertisement information.

The attribute information obtainer may obtain attribute information about the web page as the attribute information related to the specific piece of advertisement information.

The attribute information obtainer may obtain attribute information that is based on information input to the web page by a user as the attribute information related to the specific piece of advertisement information.

The embodiments of the present invention are applicable to a relevance index correction apparatus and a relevance index correction method that are configured to appropriately grasp the relevance regarding specific advertisement information.

What is claimed is:

1. A relevance index correction apparatus comprising:
an attribute information obtainer configured to obtain, in response to selection of a specific piece of advertisement information that is to be posted on a web page, attribute information related to the specific piece of advertisement information;
a relevance index generator configured to generate an apparent relevance index and a mean relevance index, the apparent relevance index indicating an apparent degree of relevance of the attribute information with respect to the specific piece of advertisement information, the mean relevance index indicating a mean degree of relevance of the attribute information with respect to all of a plurality of pieces of advertisement information; and
a specific relevance index calculator configured to calculate, in accordance with the apparent relevance index and the mean relevance index, a specific relevance index that indicates a true degree of relevance of the attribute information with respect to the specific piece of advertisement information.

2. The relevance index correction apparatus according to claim 1, wherein the specific relevance index calculator calculates the specific relevance index by subtracting the mean relevance index from the apparent relevance index.

3. The relevance index correction apparatus according to claim 1, wherein the specific relevance index calculator calculates the specific relevance index, which is represented by F, in accordance with the apparent relevance index, which is represented by E, and the mean relevance index, which is represented by M, by using an equation F=log (E/M).

4. The relevance index correction apparatus according to claim 1, further comprising:
a characteristic attribute generator configured to generate a characteristic attribute of one of the plurality of pieces of advertisement information by extracting the attribute information for which the specific relevance index has a positive value for the one piece of advertisement information; and
a selector configured to select, in accordance with the characteristic attribute, the web page to which the one piece of advertisement information is to be distributed.

5. The relevance index correction apparatus according to claim 1, wherein the attribute information obtainer obtains attribute information about a user as the attribute information related to the specific piece of advertisement information.

6. The relevance index correction apparatus according to claim 1, wherein the attribute information obtainer obtains attribute information about the web page as the attribute information related to the specific piece of advertisement information.

7. The relevance index correction apparatus according to claim 1, wherein the attribute information obtainer obtains attribute information that is based on information input to the web page by a user as the attribute information related to the specific piece of advertisement information.

8. A relevance index correction method comprising:
obtaining, in response to selection of a specific piece of advertisement information that is to be posted on a web page, attribute information related to the specific piece of advertisement information;
generating an apparent relevance index that indicates an apparent degree of relevance of the attribute information with respect to the specific piece of advertisement information;
generating a mean relevance index that indicates a mean degree of relevance of the attribute information with respect to all of a plurality of pieces of advertisement information; and
calculating, in accordance with the apparent relevance index and the mean relevance index, a specific relevance index that indicates a true degree of relevance of the attribute information with respect to the specific piece of advertisement information.
